(19) United States
(12) Patent Application Publication
(10) Pub. No.: US 2012/0104736 A1
(43) Pub. Date: May 3, 2012

(54) DRIVER AIRBAG APPARATUS FOR VEHICLE

(75) Inventor: Eung Joo Kim, Suwon-si (KR)

(73) Assignee: Hyundai Motor Company, Seoul (KR)

(21) Appl. No.: 13/047,530

(22) Filed: Mar. 14, 2011

(30) Foreign Application Priority Data
Oct. 28, 2010 (KR) 10-2010-0106346

(51) Int. Cl. B60R 21/16

(52) U.S. Cl. 280/731

(57) ABSTRACT

A driver airbag apparatus for a vehicle may include a housing having a portion configured to be open when a vehicle collision occurs, a retainer ring installed in the housing, an inflator fastened to the retainer ring, an airbag cushion to be deployed towards a driver by a gas supplied from the inflator thereinto when the vehicle collision occurs, and a control unit guiding the airbag cushion such that when the vehicle collision occurs while the driver may be in a chin-on-rim position, some of a force of deploying the airbag cushion may be applied to the airbag cushion in a direction opposite to a direction in which the airbag cushion may be deployed.

### CROSS-REFERENCE TO RELATED APPLICATIONS

The present application claims priority to Korean Patent Application No. 10-2010-0106346 filed on Oct. 28, 2010, the entire contents of which is incorporated herein for purposes by this reference.

### BACKGROUND OF THE INVENTION

1. Field of the Invention

The present invention relates generally to driver airbag apparatuses for vehicles and, more particularly, to a driver airbag apparatus for vehicles which realizes low risk deployment to minimize the rate of injury to a driver when a vehicle collision occurs while the driver is in a chin-on-rim position.

2. Description of Related Art

Generally, airbag systems for vehicles are safety devices which deploy airbag cushions so that impact is absorbed and prevent passengers from springing out of vehicle bodies when vehicle collisions occur. The airbag systems for vehicles are classified into a driver airbag (DAB) and a passenger airbag (PAB) which protect passengers who sit on front seats when a vehicle is in a front collision, and a side airbag (SAB) and a curtain airbag (CAB) which protect the sides of the passengers when a vehicle is in a side collision.

As shown in FIGS. 1 and 2, when a driver sits on a seat in an abnormal position, for example, the body of the driver is excessively close to the steering wheel of the vehicle, if an airbag cushion deploys, the driver may be heavily injured by the airbag cushion. To prevent this, the safety regulations of North America regulate the injury rate of drivers which may be injured when airbags deploy while the drivers are in abnormal positions. This is the North American safety regulations for low risk deployment (LRD). A chin-on-module position of FIG. 1 and a chin-on-rim position of FIG. 2 are two kinds of test driver positions regulated by the safety regulations. The chin-on-module position is a test driver position which addresses the condition that the chin of the driver collides with an airbag module. The chin-on-rim position is a test driver position which addresses the condition that the chin of the driver collides with the rim of a steering wheel.

As shown in FIG. 3, in a conventional driver airbag apparatus, when the driver is in the chin-on-rim position and the airbag cushion is deployed towards the neck of the driver, there is a problem in that the neck of the driver may be bent or the airbag cushion may severely injure the chest of the driver.

In an effort to overcome this problem, a dual-stage inflator (using low pressure of 120 kpa and high pressure of 210 kpa) was proposed. The dual-stage inflator realized a low risk deployment structure which reduced a driver injury resulting from the airbag cushion when an airbag cushion deploys. However, the use of the dual-stage inflator increases production cost. Airbag systems of North America and other areas are dualized, thereby increasing the development cost. Furthermore, the number of electric connection devices required by the airbag system is increased. This may cause an error when several electric lights are turned on or off.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide a driver airbag apparatus for vehicles which is configured such that when an airbag cushion deploys, a predetermined amount of force is selectively applied to the airbag cushion in the direction opposite to the direction in which the airbag cushion deploys, thus minimizing the rate of injury to a driver when the vehicle collision occurs while the driver is in a chin-on-rim position.

In an aspect of the present invention, the driver airbag apparatus for a vehicle, may include a housing having a portion configured to be open when a vehicle collision occurs, a retainer ring installed in the housing, an inflator fastened to the retainer ring, an airbag cushion to be deployed towards a driver by a gas supplied from the inflator thereinto when the vehicle collision occurs, and a control unit guiding the airbag cushion such that when the vehicle collision occurs while the driver may be in a chin-on-rim position, some of a force of deploying the airbag cushion may be applied to the airbag cushion in a direction opposite to a direction in which the airbag cushion may be deployed.

The airbag cushion may include an upper panel provided at a side facing the driver, and a lower panel provided at a side opposite to the upper panel, wherein the lower pane may be adjacent to the housing, wherein the control unit may include a strap connecting a portion of the retainer ring to a portion of the lower panel.

The driver airbag apparatus may further include a tether connecting an inner surface of the upper panel to an inner surface of the lower panel, the tether being provided separately from the strap.

The driver airbag apparatus may include a plurality of tethers connecting an inner surface of the upper panel to an inner surface of the lower panel, the tethers being spaced with a predetermined distance.

The retainer ring may have an annular shape being open in a central portion thereof to which the inflator may be mounted.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a photograph showing the result of a chin-on-module test of a conventional driver airbag apparatus for low risk deployment.

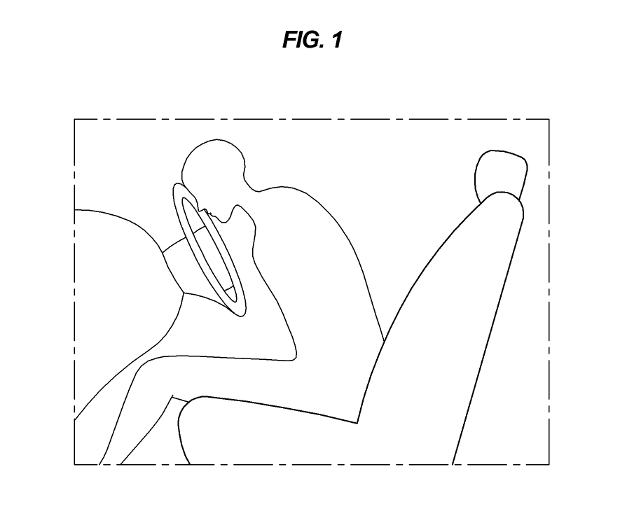

FIG. 2 is a photograph showing the result of a chin-on-rim test of the conventional driver airbag apparatus for low risk deployment.

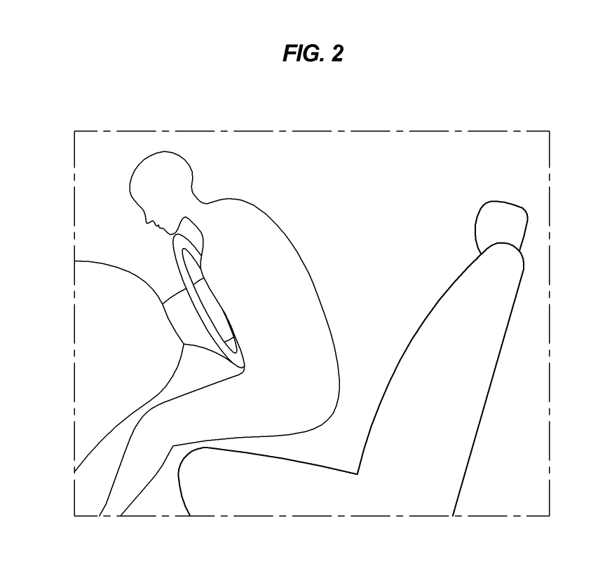

FIG. 3 is of photographs showing a deployment process of an airbag cushion in the chin-on-rim test of the conventional driver airbag apparatus for low risk deployment.

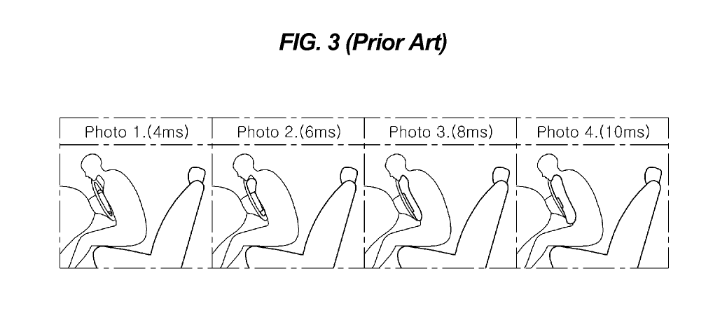

FIG. 4 is a view of a driver airbag apparatus for vehicles, according to an exemplary embodiment of the present invention.

FIG. 5 is a photograph showing the result of a chin-on-rim test of the airbag apparatus for low risk deployment according to an exemplary embodiment of the present invention.

FIG. 6 is of photographs of a deployment process of an airbag cushion when a driver sits on a driver seat in a normal position according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a driver airbag apparatus for vehicles according to an exemplary embodiment of the present invention will be described in detail with reference to the attached drawings.

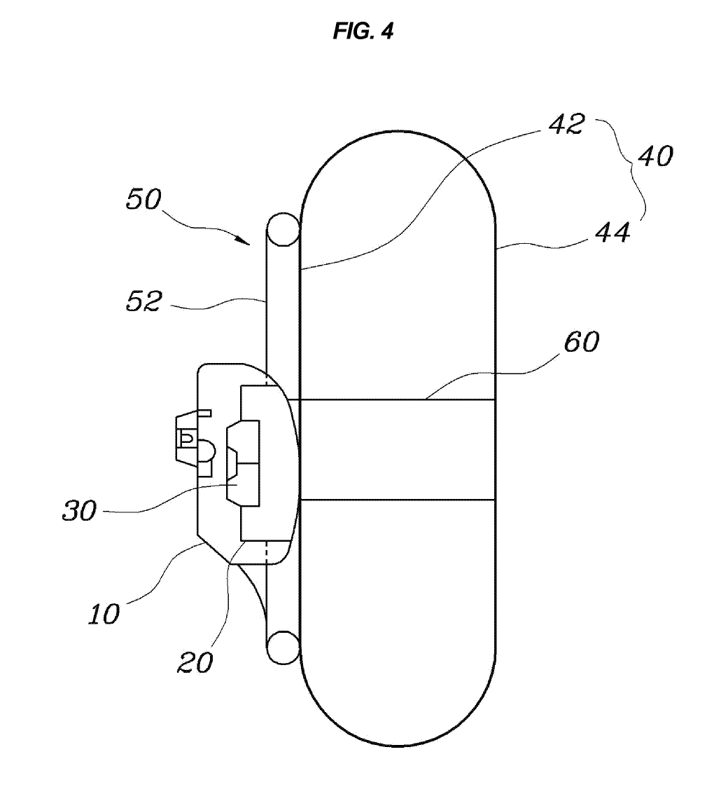

As shown in FIG. 4, the driver airbag apparatus according to an exemplary embodiment of the present invention includes a housing 10, a retainer ring 20, an inflator 30, an airbag cushion 40 and a control unit 50.

The housing 10 is installed in a steering wheel. One surface of the housing 10 is made of soft material so that when the vehicle is involved in a collision accident, the soft surface of the housing 10 is open and then the airbag cushion 40 can be deployed towards the driver.

The retainer ring 20 is provided in the housing 10. The retainer ring 20 retains, in the housing 10, the inflator 30 which will be explained later herein. The retainer ring 20 has an annular shape which is open on a central portion thereof. The inflator 30 is mounted to the open central portion of the retainer ring 20.

When a vehicle collision occurs, the inflator 30 receives a relevant signal and thus supplies gas into the airbag cushion 40 in response to the signal. Then, the airbag cushion 40 is deployed towards the driver by the pressure of gas supplied from the inflator 30.

The control unit 50 controls the airbag cushion 40 such that when the vehicle collision occurs while the driver is in the chin-on-rim position, a predetermined amount of force is applied to the airbag cushion in the direction opposite to the direction in which the airbag cushion deploys. In other words, if the airbag cushion 40 is directly deployed towards the driver who is in the chin-on-rim position, the airbag cushion 40 may inflict bodily injury to the chest or the neck of the driver. The control unit 50 applies force to the airbag cushion 40 in the direction opposite to the direction in which the airbag cushion 40 deploys, so that a lower panel 42 of the airbag cushion 40 is guided behind a rim of the steering wheel when the airbag cushion 40 deploys.

The airbag cushion 40 includes a lower panel 42 and an upper panel 44. The upper panel 44 is disposed at a position facing the driver so that when the vehicle collision occurs, the upper panel 44 directly comes into contact with the neck or the chest of the driver. The upper panel 44 is disposed at a side opposite to the lower panel 42 mounted adjacent to the housing 10. A tether 60 couples an inner surface of the lower panel 42 to an inner surface of the upper panel 44. The tether 60 functions to control the thickness of the airbag cushion 40 when it deploys. In other words, the distance between the lower panel 42 and the upper panel 44 when the airbag cushion 40 deploys can be determined by adjusting the length of the tether 60. This is directly related to the internal pressure of the airbag cushion 40.

It is desirable that the control unit 50 include a strap 52 which connects a portion of the retainer ring 20 to a portion of the lower panel 42. The strap 52 is separately provided from the tether 60 and disposed outside the airbag cushion 40. That is, the strap 52 connects the lower panel 42 to the retainer ring 20 so that when the airbag cushion 40 deploys, force is applied to the airbag cushion 40 in the direction opposite to the direction in which it deploys.

Therefore, when the airbag cushion 40 deploys resulting from the vehicle collision, the strap 52 relatively pulls the lower panel 42 towards the retainer ring 20. Thus, force is applied to the airbag cushion 40 in the direction opposite to the direction in which it deploys. Therefore, only some of the deployment pressure of the airbag cushion 40 is applied to the driver. As a result, there is a reduced rate of injury of the driver attributable to the deployment pressure of the airbag cushion 40. Furthermore, in the case where the driver is in the normal position rather than the chin-on-rim position, the strap 52 snaps when the airbag cushion 40 deploys. Therefore, the airbag cushion 40 can protect the driver in the normal manner.

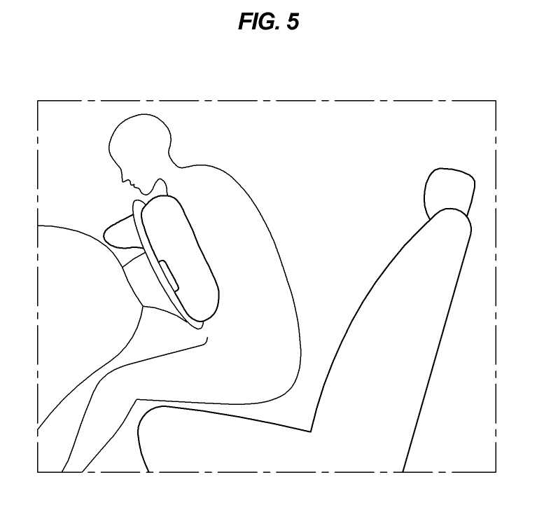

As shown in FIG. 5, in the driver airbag apparatus according to an exemplary embodiment of the present invention, when the airbag cushion 40 deploys in the chin-on-rim test for low risk deployment, the upper portion of the airbag cushion is guided behind the rim of the steering wheel. Thus, the rate of injury of the chest or neck of the driver can be reduced.

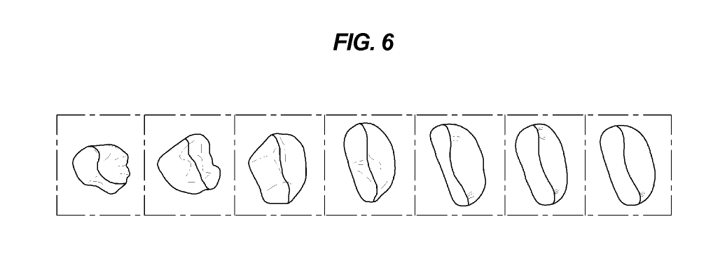

As shown in FIG. 6, in the case where the driver sits on the driver seat in the normal position, when the airbag cushion 40 deploys, the strap 52 snaps. Thereby, the airbag cushion 40 deploys in the normal manner, thus reliably protecting the driver.

Investigations were conducted and showed that when the driver airbag apparatus has no strap, impact applied to the head and neck of the driver is beyond the reference level (100%), and when the driver airbag apparatus has the strap, it is less than 50%.

As such, in the case where the strap is used, when a vehicle collision occurs, force is applied to the airbag cushion in the direction opposite to the direction in which it deploys. Thereby, impact applied to the head or neck of the driver by the deployment pressure of the airbag cushion can be minimized.

As described above, in a driver airbag apparatus of the present invention having the above-mentioned technical construction, when a vehicle collision occurs, the rate of injury of a driver who is in a chin-on-rim position can be minimized. Moreover, the present invention does not require a separate dual-stage inflator structure, thus reducing the production cost and the development cost.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A driver airbag apparatus for a vehicle, comprising:
a housing having a portion configured to be open when a vehicle collision occurs;
a retainer ring installed in the housing;
an inflator fastened to the retainer ring;
an airbag cushion to be deployed towards a driver by a gas supplied from the inflator thereinto when the vehicle collision occurs; and
a control unit guiding the airbag cushion such that when the vehicle collision occurs while the driver is in a chin-on-rim position, some of a force of deploying the airbag cushion is applied to the airbag cushion in a direction opposite to a direction in which the airbag cushion is deployed.

2. The driver airbag apparatus as set forth in claim 1, wherein the airbag cushion comprises:
an upper panel provided at a side facing the driver; and a lower panel provided at a side opposite to the upper panel, wherein the lower pane is adjacent to the housing.

3. The driver airbag apparatus as set forth in claim 2, wherein the control unit comprises a strap connecting a portion of the retainer ring to a portion of the lower panel.

4. The driver airbag apparatus as set forth in claim 3, further comprising:
a tether connecting an inner surface of the upper panel to an inner surface of the lower panel, the tether being provided separately from the strap.

5. The driver airbag apparatus as set forth in claim 3, further comprising:
a plurality of tethers connecting an inner surface of the upper panel to an inner surface of the lower panel, the tethers being spaced with a predetermined distance.

6. The driver airbag apparatus as set forth in claim 1, wherein the retainer ring has an annular shape being open in a central portion thereof to which the inflator is mounted.
